(19) United States
(12) Patent Application Publication
(10) Pub. No.: US 2006/0208101 A1
(43) Pub. Date: Sep. 21, 2006

(54) Lilly pad water toy

(76) Inventors: Jeffrey A. DeBoer, Ann Arbor, MI (US); Aaron M. Hughes, San Francisco, CA (US)

Correspondence Address: CARLSON, GASKEY & OLDS, P.C., 400 WEST MAPLE ROAD, SUITE 350, BIRMINGHAM, MI, 48009, US

(21) Appl. No.: 11/084,442

(22) Filed: Mar. 18, 2005

(51) Int. Cl. E03B 9/20; B05B 17/08

(52) U.S. Cl. 239/16; 239/17

(57) ABSTRACT

A water toy includes a resilient pad connected to a water supply through a flexible water conduit. The resilient pad is shaped like a lilly pad, flower, leaf or other such pleasing and entertaining shape. The flexible water conduit is connected to the water source such that each resilient pad provides a spray or fountain of water in response to being squeezed or stepped upon.

### BACKGROUND OF THE INVENTION

The present invention relates to a water toy, and more particularly to a resilient pad which sprays a shower of water in response to being squeezed.

Many young children enjoy playing in water and water toys often facilitate bathing of children. Children are often particularly fascinated and entertained by toys that spray water. There are numerous bath toys on the market that are both fun and stimulating for young children, but in general, there are not many bath toys that spray or project one or more streams of water.

Accordingly, it is desirable to provide an uncomplicated bath toy which is entertaining to children though the projection of a pleasing stream of water.

### SUMMARY OF THE INVENTION

A water toy according to the present invention includes a resilient pad connected to a water supply through a flexible water conduit. The resilient pad is in communication with a network of secondary resilient pads. The resilient pad and the secondary resilient pads are shaped like a lilly pad, flower, leaf or other such pleasing and entertaining shape.

The flexible water conduit is connected to the water source such that each of the resilient pad and secondary resilient pads provide a spray or fountain of water in response to being squeezed or stepped upon. The resilient pad and secondary resilient pads float upon the surface of the water so that the resilient pads readily available to play with. Alternatively, the resilient pad and secondary resilient pads sink such that a shower of water is sprayed in response to being stepped upon.

The present invention therefore provides an uncomplicated bath toy which is entertaining to children though the projection of a pleasing stream of water.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of a water toy designed according to the present invention; and

FIG. 2 is a general perspective view of another embodiment of a water toy designed according to the present invention.

### DETAILED DESCRIPTION OF THE PREFERRED EMBODIMENT

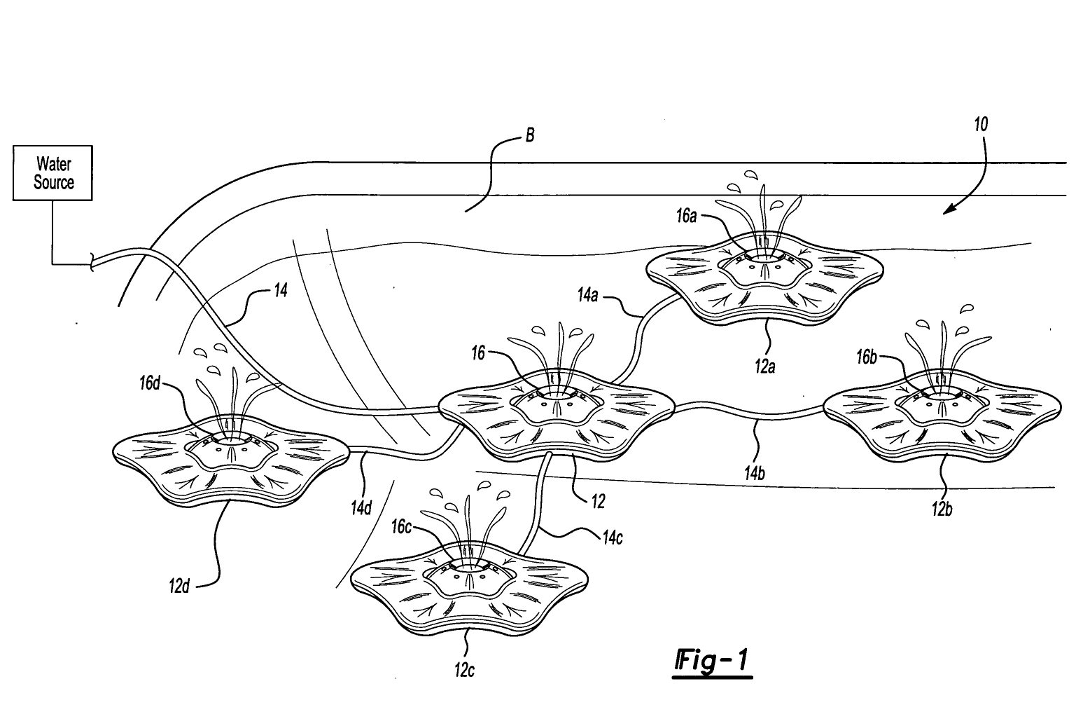

FIG. 1 illustrates a general perspective view of a water toy 10 for a bath B or the like. The water toy 10 includes a resilient pad 12 connected to a water supply through a flexible water conduit 14. The resilient pad 12 is preferably in communication with a network of secondary resilient pads 12a-12d through respective flexible water conduits 14a-14d which communicate with the primary resilient pad. It should be understood that any number of flexible pads and various flexible communication conduit connections are usable with the present invention, as well as just a single resilient pad.

The resilient pad 12 and secondary resilient pads 12a-12d are preferably shaped like a lilly pad, flower, leaf or other such pleasing and entertaining shape. Most preferably, the resilient pads 12 and 12a-12d are relatively small such as to be readily handled and played with by a small child.

The flexible water conduit 14 is preferably connected to the water source through a faucet or the like. The water source thereby effectively pressurizes each resilient pad 12 and secondary resilient pads 12a-12d. Each of the resilient pad 12 and secondary resilient pads 12a-12d includes one or more spray apertures 16 which are selectively opened in response to compression of the resilient pads 12, and 12a-12d such as through squeezing or being stepped upon. One of ordinary skill in the art of fluid communication will be able to readily provide an uncomplicated valve that responds to pressure to project a spray or fountain of water. Alternatively, the resilient pad 12 and secondary resilient pads 12a-12d may be utilized without a valve to directly fill the bath.

The resilient pad 12 and secondary resilient pads 12a-12d preferably float upon the surface of the water to provide ready access to a bathing child. Floating of the resilient pad 12 and secondary resilient pads 12a-12d provides entertainment in itself. That is, the floating objects attract attention and are readily available to play with.

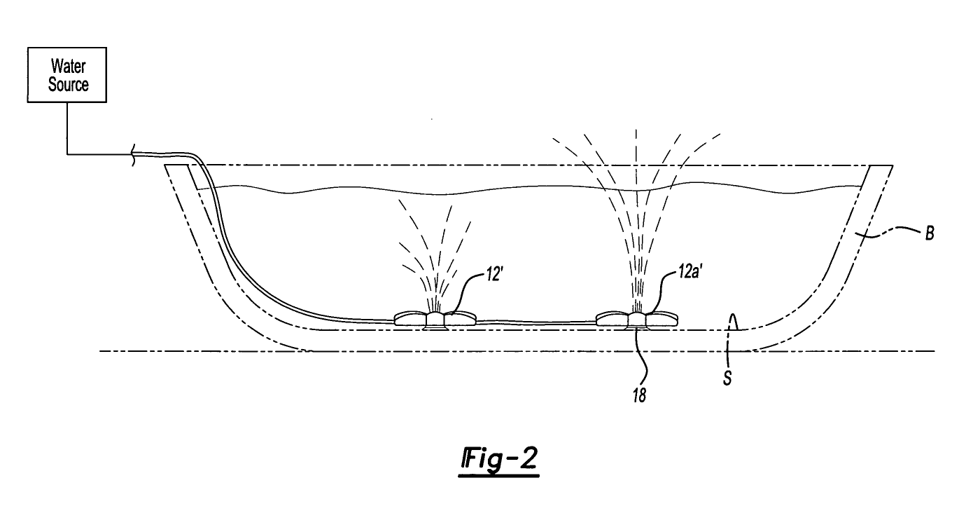

Referring to FIG. 2, the resilient pad 12′ and secondary resilient pads 12a′ are alternatively attachable underwater to a bottom surface S of a tub or shower base B through an attachment such as a suction cup attachment 18 (illustrated schematically). Alternatively, the resilient pad 12′ and secondary resilient pads 12a′ may be adhesively attached. Most preferably, the resilient pad 12′ and secondary resilient pads 12a′ are weighted so as to sink to the bottom surface S. The resilient pad 12′ and secondary resilient pads 12′ operate such that a shower of water is sprayed in response to being stepped upon.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A water toy comprising:
a water conduit; and
a resilient pad connected to said water conduit to spray a shower of water.

2. The water toy as recited in claim 1, wherein said resilient pad includes a lilly pad shape.

3. The water toy as recited in claim 1, wherein said resilient pad is mountable to a shower base, said resilient pad spraying a shower of water in response to being stepped on.

4. The water toy as recited in claim 1, wherein said resilient pad floats, said resilient pad spraying a shower of water in response to being compressed.

5. The water toy as recited in claim 1, wherein said resilient pad is attachable to a surface under water.

6. The water toy as recited in claim 1, wherein said resilient pad is in communication with a multitude of secondary resilient pads.

7. A water toy comprising:
a water conduit;
a resilient pad connected to said water conduit to spray a shower of water in response to being compressed; and
a multitude of secondary resilient pads connected to said resilient pad, each of said multitude of secondary resilient pads spraying a shower of water in response to being compressed.

8. The water toy as recited in claim 7, wherein said resilient pad includes a lilly pad shape.

9. The water toy as recited in claim 7, wherein said resilient pad is mountable to a shower base, said resilient pad spraying a shower of water in response to being stepped on.

10. The water toy as recited in claim 7, wherein said resilient pad floats.

11. A method of spraying stream of water from a bath toy comprising the steps of:
(1) connecting a resilient pad to a source of water;
(2) squeezing the resilient pad; and
(3) spraying a shower of water from the pad.

12. A method as recited in claim 11, further comprising the step of:
attaching the resilient pad to a bottom of a tub; and
stepping on the resilient pad to spray the shower of water.

13. A method as recited in claim 11, further comprising the step of:
floating the resilient pad in a body of water.
